(19) United States
(12) Patent Application Publication
(10) Pub. No.: US 2016/0330946 A1
(43) Pub. Date: Nov. 17, 2016

(54) CRAWFISH LURE

(71) Applicant: Paul Sarris, Whitby (CA)

(72) Inventor: Paul Sarris, Whitby (CA)

(21) Appl. No.: 14/712,670

(22) Filed: May 14, 2015

(51) Int. Cl. A01K 85/02; A01K 85/00

(52) U.S. Cl. CPC A01K 85/02; A01K 85/00

(57) ABSTRACT

A crawfish lure comprising a lure body shaped like a crawfish and composed of an elastic material. A tail element is coupled to the rear of the lure body. The tail element is shaped like a crawfish tail and offset from the body's centerline. Three pads located within the tail element are configured for inserting weights such that pulling the lure in a rearward direction results in the tail element dropping underneath the lure body. A pair of claws coupled to opposing sides of the lure body provide counterweights on either side of the lure body. A hook is inserted into the crawfish lure such that the hook is oriented for contact with a fish attacking from a front of the lure body and such that the eye of the hook is located at the rear of the lure and is not obstructed by the tail element.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

This invention relates to the field of fishing and outdoor sports, and more specifically, to the field of fishing lures.

### BACKGROUND

Modern humans have enjoyed fishing for thousands of years. In fact, fishing dates back to early man, when individuals began to fish in order to feed themselves and their families The oldest known painting of an angler dates back to 2000 BC and comes from Egypt. It is reported that the use of lures also dates back to ancient Greek and Roman culture. It is well known that artificial lures were recognized and valued in ancient times and throughout history.

As time progressed, fishing and fishing equipment evolved. Anglers have continually improved their fishing gear, tactics and knowledge of fish behavior. In recent times, fishing and fishing equipment has become a billion-dollar industry in the United States, as well as throughout the world. The increase in popularity has led to an increased interest in the various methods of fishing for, and attracting, fish.

Fishermen are constantly searching for artificial lures that more closely resemble a fish's natural prey. Additionally, fishermen are constantly searching for lures that more closely simulate a fish's movement while in the water. Currently, in many situations, a lure may resemble a fish's prey, however such lure does not accurately simulate such prey's movement.

In certain instances, a lure may accurately simulate a prey's movement, however, the lure may not accurately resemble the prey. Currently, there is no lure available that accurately resembles a various aquatic life, which is the prey of many predator fish, and that also simulates the natural movement of said aquatic life. As a result, many fishermen may become frustrated when fishing for predator fish whose natural prey is said aquatic life. Additionally, many predator fish are less likely to attack or bite a lure that does not accurately closely resemble and simulate its natural prey.

As a result, there exists a need for improvements over the prior art and more particularly for a lure that accurately resembles and simulates the movement of aquatic life.

### SUMMARY

A crawfish lure is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a crawfish lure is disclosed. The lure comprises a lure body shaped like a crawfish and composed of an elastic material. A tail element is coupled to a rear portion of the lure body via a narrow link. The tail element is shaped like a crawfish tail and offset from a centerline of the lure body. One or more pads are located within the tail element. The pads are configured for inserting weights such that pulling the lure body in the rear direction results in the tail element dropping underneath the lure body. A pair of claws are coupled to opposing sides of the lure body. The claws provide counterweights on either side of the lure body. A hook is inserted into the crawfish lure via the centerline of the lure body such that the hook is oriented for contact with a fish attacking from a front of the lure body and such that the eye of the hook is located at a rear of the lure body and is not obstructed by the tail element.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a top view of an illustration of the crawfish lure according to an example embodiment;

FIG. 2 is a side view of an illustration of the crawfish lure according to an example embodiment; and,

FIG. 3 is a side view of an illustration of the crawfish lure being pulled in a rear direction, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a lure that closely and accurately resembles and simulates the movement of a live crawfish. The disclosed embodiment has a tail the acts like a real crawfish tail when it is pulled through the water. The tail element also gives the crawfish stability so that it stays in the upright position as it is pulled slowly from the rear. The tail element of the crawfish is offset from the centerline of the body of the lure so that the hook can be inserted into the body of the lure while allowing the hook eye to not be interfered by the body of the lure. Additionally, the tail being offset allows for the hook to be properly rigged from the back and not to interfere with the movement or action of the tail. Additionally, the tail element of the lure has rounded pads for nail weights to be inserted into and hidden from a fish's view.

A crawfish, also known as crawfish, crawdads, freshwater lobsters, or mudbugs, are freshwater crustaceans resembling small lobsters, to which they are related. Taxonomically, crawfish are members of the super-families Astacoidea and Parastacoidea. Crawfish are eaten worldwide and are commonly sold and used as bait.

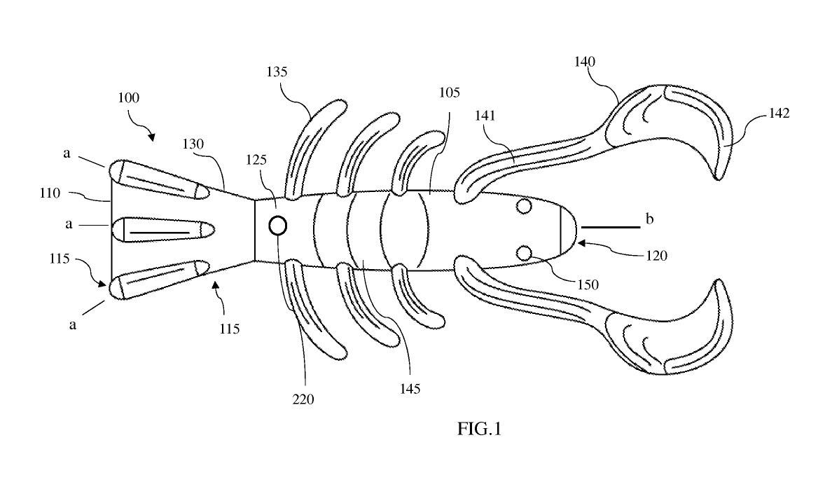

Referring to the Figures, FIG. 1 is a top view of the crawfish lure 100 according to an example embodiment. The body 100 is shaped like a crawfish and composed of an elastic material. The body have come in varying colors depending on the preference of the user and the intended location of where the fishing is to take place. The body can be an elongated oval shaped body having a front end 120 opposing a rear end 115. The front end of the body can have circular raised protrusion 150 that resemble eyes of a crawfish. It should be noted that other features of a crawfish may be used so that the body of the lure resembles or looks like the body of a crawfish. In one embodiment, the crawfish may also have elongated shaped grooves 145 across the oval shaped body that provide the body with the appearance of a shell.

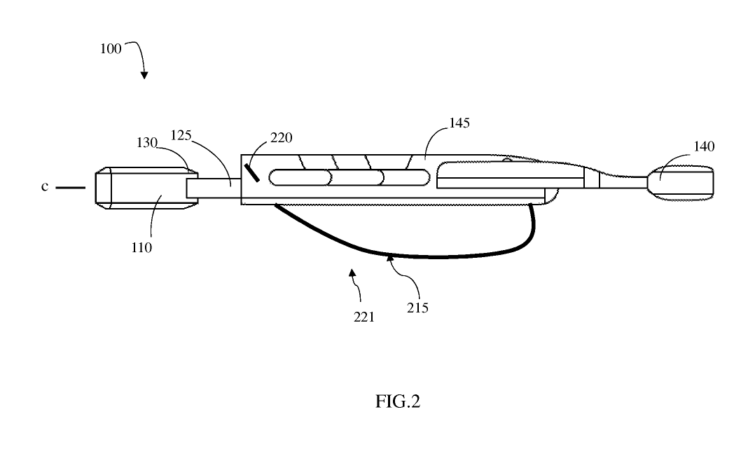

A tail element 110 is attached to the rear end of the elongated oval shaped body. The tail element is coupled to the rear portion of the lower body via a narrow link 125. The tail element is coupled offset from a centerline, represented by line c illustrated in FIG. 2). The tail element is adapted to resemble the tail of a crawfish and in one embodiment, the tail element comprises a trapezoid shaped body. One or more pads 130 one or more pads is located within the tail element. In the present embodiment three pads are shown. However, more or less pads may also be used depending on user preference and the size of the lure. In the present embodiment, the pads are somewhat parallel to each other and situated such that a longitudinal axis of the pads (represented by line a) is situated in the same direction as with the longitudinal axis of the body (represented by line b).

Each of the pads is configured for inserting weights (not shown), such as nail weights. The material of each of the pads comprises material that allows weights to be inserted into the pads. Nail weights are elongated shaft with a point end, similar to the shape of nails. The nail weights can be inserted into the pads by applying force so that the point of the nail pierces the material of the pad so that the nail can enter into the pads. The nail weight may also have barbs on the shaft so that the shaft grabs onto the body of the pad so that the shaft of then nail weight can remain inside the pads after insertion into the pad. The pads are sized so that it increases the dimension of the tail so that a nail weigh may be inserted into the pad. The pads are cylindrical shaped bodies that extend above and below the body of the tail element 110.

After insertion into each of the pads, the nail weights can be hidden from view and cannot be seen by predator fish. The nail weights, after being inserted into the pads, cause the tail element to drop underneath the lure body when the lure body is pulled in a rearward or rear direction (further explained below). The movement of the tail dropping below the body of the crawfish is very similar to the motion that a crawfish makes in order to swim.

The lure body also includes a pair of claws 140 coupled to the front portion of the oval shaped lure body. In the present embodiment, each of the claws has an elongated circular shaft 141 or arm having a first end connected proximate to the front end of the lure body. A semicircular shaped body 142 is connected to an opposing second end of the elongated shaft or arm. The claws and arms can be weighted so as to provide counterweights to either side of the oval shaped lure body. In one embodiment, the claws can comprises material that allows a nail weight to be received into the claw so that the claw may have additional weight if necessary. The first end of each arm can be coupled to or can with integral with the lure body.

In the present embodiment, the lure body may also include elongated circular shafts or bodies 135 that resemble the legs of a crawfish. The shafts or legs are curved towards the front end 120 of the body of the lure. In the present embodiment, three legs are attached on both sides of the oval shaped lure body. However, in other embodiments, additional or fewer legs may also be used. The first end of each leg can be affixed to or can with integral with the lure body.

FIG. 2 is a side view of an illustration of the crawfish lure, according to an example embodiment. FIG. 2 further illustrates a hook 215 attached to the body of the lure. The hook can be a typical fish hook having an eye 220, which is a ring having an opening that is adapted for receiving fishing line or wire, which is attached to an elongated curved shaft having a point (not shown) on the opposing second end of the shaft. Such fish hooks are well known to those skilled in the art and be of varying sizes and materials. In the present embodiment, the hook is inserted into via the centerline of the lure body, such that the hook is oriented for contact with the fish attacking from a front end 120 of the lure body. In the present embodiment, the point on the second end of the hook has been inserted into the elastic lure body.

The fact that the tail element 110 is coupled to the lure body 105 offset from the centerline c of the lure body and located proximate to the rear portion of the lure body allows for the hook eye 220 to not be obstructed by the tail element. As illustrated in FIG. 1, the eye 220 of the hook is unobstructed and allows for the hook to be properly rigged from the back and not to interfere with the movement or action of the tail.

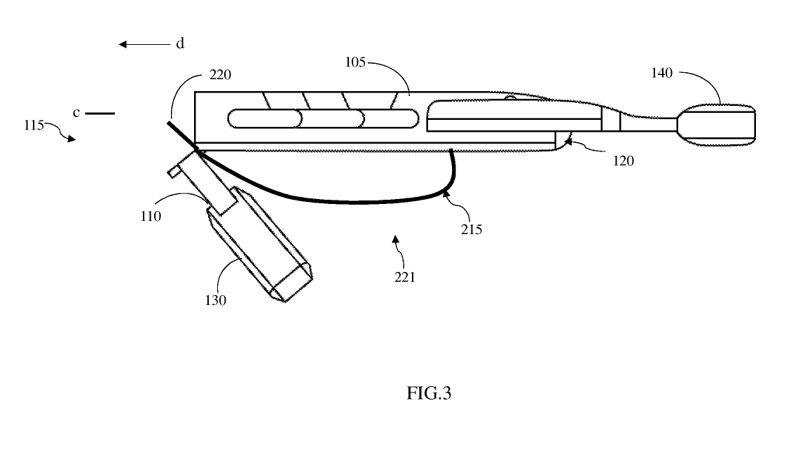

FIG. 3 is a side view of an illustration of the crawfish lure being pulled in a rear direction, according to an example embodiment. FIG. 3 illustrates that when the lure is pulled in the direction of arrow d, towards the rear end 115 of the lure, the tail or trapezoidal shaped body drops into the area underneath 220 the lure body due to the weights inserted into the pads of the tail element. The tail dropping underneath the body of lure simulates the swimming motion of a crawfish. This figure also illustrates that when the eye 220 of the hook is unobstructed because the tail is coupled offset from the centerline c of the body of the lure. Additionally because the tail element of the crawfish is offset from the centerline of the body of the lure, the hook can be inserted into the body of the lure while allowing the hook eye to not be interfered by the body of the lure. Additionally, the tail being offset allows for the hook to be properly rigged from the back and not to interfere with the movement or action of the tail.

In operation, the sharp point of the hook is used to puncture the body 105 of the lure at the centerline proximate to where the tail element and the lure body are coupled together. Next, the shaft of the hook is manipulated though the punctured portion of the body and maneuvered so that the point of the hook can be used to puncture the bottom side of the body of lure proximate to the front of the lure. Next, the user will puncture the lure body with the point of the hook so that second end and the point of the hook can be hidden from fish. When the hook is in inserted in this manner the hook is situated for fish that are attaching the lure from the front of the lure body. Next, a line or string and be tied to the opening of the eye of the hook.

Next, a user can cast the lure that is tied to a line into water. While in water, a user can apply force to move the lure in the direction of arrow d by reeling in the line or by other movements. The movement of the lure towards the rear causes the tail element of the lure to drop downward underneath the bottom of the lure due to the weights that have been inserted into the pads of the tail or trapezoidal shaped element. As a result, this causes the lure to simulate the motion of a crawfish, which swims backwards by curling its tail underneath its body when it swims.

The lure body, tail element, claws, pads, and legs can comprise a variety of materials. The lure body shall comprise material that allows a fish hook to pass though the body, such as synthetic polymers. Such polymers are well known to those skilled in the art. The components of the lure can be manufactured using injection molding and molds or other processes that are well known to those skilled in the art.

Although specific embodiments of the invention have been disclosed, those having ordinary skill in the art will understand that changes can be made to the specific embodiments without departing from the spirit and scope of the disclosed embodiments. The scope of the invention is not to be restricted, therefore, to the specific embodiments. Furthermore, it is intended that the appended claims cover any and all such applications, modifications, and embodiments within the scope of the disclosed embodiments

1. A crawfish lure, comprising:
a lure body shaped like a crawfish and composed of an elastic material;
a tail element coupled to a rear portion of the lure body via a narrow link, the tail element shaped like a crawfish tail and offset from a centerline of the body;
one or more pads located within said tail element, said pads configured for inserting weights, such that pulling the lure body in the rear direction results in the tail element dropping underneath the lure body;
a pair of claws coupled to opposing sides of the lure body, wherein said claws provide counterweights on either side of the lure body; and
a hook inserted into the crawfish lure via the centerline of the lure body, such that the hook is oriented for contact with a fish attacking from a front of the lure body, and wherein an eye of the hook is located at a rear of the lure body and is not obstructed by the tail element.

2. The crawfish lure of claim 1, wherein the pads are comprised of material configured for insertion of a nail weight.

3. The crawfish lure of claim 1, wherein the tail element comprises three elongated pads, wherein each of the pads is situated such that a longitudinal axis of each of the pads is substantially aligned in the direction of a longitudinal axis of lure body.

4. The crawfish lure of claim 1, wherein the lure body and tail element comprise material such that a point of the hook can pierce through the material.

5. The crawfish lure of claim 1, wherein the lure body has a first side opposing a second side, wherein three legs protrude outward from each side of the body, wherein each leg is shaped like legs of a crawfish.

6. The crawfish lure of claim 5, wherein each leg has an elongated cylindrical shaped body that curves towards the front end of the lure body.

7. The crawfish lure of claim 1, wherein each claw comprises an elongated cylindrical body having a first end opposing a second end, wherein the first end is affixed proximate to the front end of the lure body, and wherein a semicircular shaped body is affixed to the second end.

8. A lure body shaped like a crawfish and composed of an elastic material;
a tail element coupled to a rear portion of the lure body via a narrow link, the tail element shaped like a crawfish tail and offset from a centerline of the body;
three pads located within said tail element, each pad configured for inserting a nail weight, such that pulling the lure body in the rear direction results in the tail element dropping underneath the lure body;
a nail weight for insertion into each elongated pad;
a pair of claws coupled to opposing sides of a front portion of the lure body, wherein said claws provide counterweights on either side of the lure body, wherein each claw comprises an elongated cylindrical body having a first end opposing a second end, wherein the first end is affixed proximate to the front end of the lure body and wherein a semicircular shaped body is affixed to the second end; and,
a hook inserted into the crawfish lure via the centerline of the lure body, such that the hook is oriented for contact with a fish attacking from a front of the lure body, and wherein an eye of the hook is located at a rear of the lure body and is not obstructed by the tail element.

9. The crawfish lure of claim 8, wherein the lure body and tail element comprise material such that a hook having a point can pierce the through the body.

10. The crawfish lure of claim 9, wherein the lure body has a first side opposing a second side, wherein three legs protrude outward from each side of the body, and wherein each leg is shaped like legs of a crawfish.

11. The crawfish lure of claim 10, wherein each leg has an elongated cylindrical shaped body that curves towards the front end of the lure body.

12. A crawfish lure, comprising:
a elongated oval shaped body composed of an elastic material;
a trapezoidal shaped element to a rear portion of the lure body, the trapezoidal shaped element offset from a centerline of the oval body;
said trapezoidal shaped element configured for inserting weights, such that pulling the oval body in the rear direction results in the tail element dropping underneath the oval body;
a pair of arms having a claw at one end of the claw coupled to opposing sides of a front portion of oval shaped body, wherein said arms and claws provide counterweights on either side of the oval shaped body; and
a hook inserted into the crawfish lure via the centerline of the oval shaped body, such that the hook is oriented for contact with a fish attacking from a front of the oval shaped body, and wherein an eye of the hook is located at a rear of the oval shaped body and is not obstructed by the trapezoidal shaped element.

13. The crawfish lure of claim 12, wherein the oval shaped body is shaped like a crawfish body and wherein the trapezoidal shaped element is shaped like a crawfish tail.

14. The crawfish lure of claim 12, wherein the trapezoidal shaped element is comprised of material configured for receiving a nail weight.

15. The crawfish lure of claim 12, wherein the weights are nail weights and wherein the trapezoidal shaped element comprises one or more pads comprised of material configured for receiving a nail weight.

16. The crawfish lure of claim 12, wherein the oval body and trapezoidal shaped element comprise material such that a point of the hook can pierce the through the oval shaped body and trapezoidal shaped element.

17. The crawfish lure of claim 12, wherein the oval shaped body has a first side opposing a second side, wherein three legs protrude outward from each side of the body, and wherein each leg defines an elongated cylindrical shaped body curved towards the front end of the oval shaped body.

18. The crawfish lure of claim 17, wherein each claw is shaped like the claws of a crawfish.

19. The crawfish lure of claim 17, wherein each claw is weighted sufficiently to provide counterweights on either side of the oval shaped body.
